(19) United States
(12) Patent Application Publication
(10) Pub. No.: US 2025/0236698 A1
(43) Pub. Date: Jul. 24, 2025

(54) POLYURETHANE MATERIALS COMPRISING LIGNIN AND METHODS OF MANUFACTURING THE SAME

(71) Applicant: GM GLOBAL TECHNOLOGY OPERATIONS LLC, Detroit, MI (US)

(72) Inventors: Ashley Dustin, Santa Monica, CA (US); Janet C. Robincheck, Sterling Heights, MI (US); Edward Thaddeus Kuczynski, Ann Arbor, MI (US); Zach Hern, Los Angeles, CA (US); Dylan Hollrigel, Woodland Hills, CA (US); Andrew P. Nowak, Winnetka, CA (US); Matthew Vandyke, Davison, MI (US); Megan Shewey, Saint Clair Shores, MI (US)

(21) Appl. No.: 18/419,730

(22) Filed: Jan. 23, 2024

(51) Int. Cl. C08G 18/40; C08G 18/48; C08G 18/64; C08J 9/00; C08L 75/08

(52) U.S. Cl. CPC C08G 18/4081; C08G 18/4841; C08G 18/6492; C08J 9/0061; C08L 75/08; C08G 2110/005; C08G 2110/0058; C08G 2110/0066; C08J 2375/08; C08J 2483/04; C08L 2203/14

(57) ABSTRACT

A polyurethane material including the reaction product of a polyol, lignin, a catalyst; and a polyisocyanate. The polyol including an amphiphilic polyoxyalkylene copolymer having at least two terminal primary or secondary hydroxyl groups. The amphiphilic polyoxyalkylene copolymer including hydrophilic oxyalkylene groups covalently bonded to hydrophobic oxyalkylene groups. The polyurethane material may be a polyurethane foam, and the lignin may constitute, by weight, greater than 30% of the polyurethane foam.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to polyurethane materials including high lignin loadings and to methods of manufacturing such polyurethane materials.

Lignin is a natural polyol and a promising candidate for use as a polyol in the manufacture of polyurethane materials due to its abundance in nature and its production a by-product of various manufacturing processes.

### SUMMARY

A polyurethane material, in accordance with one or more embodiments of the present disclosure, comprises the reaction product of a polyol, lignin, a catalyst; and a polyisocyanate. The polyol comprises an amphiphilic polyoxyalkylene copolymer having at least two terminal primary or secondary hydroxyl groups. The amphiphilic polyoxyalkylene copolymer comprises hydrophilic oxyalkylene groups covalently bonded to hydrophobic oxyalkylene groups.

The lignin may be a particulate material having a mean particle diameter of greater than or equal to 5 micrometers and less than or equal to 250 micrometers.

The lignin may constitute, by weight, greater than 30% of the polyurethane material. The lignin may be homogenously distributed throughout the polyurethane material.

The lignin may be a natural plant product, kraft lignin, soda lignin, organosolv lignin, sulfite lignin, lignocellulosic biomass, or a combination thereof. The lignin may not have been subjected to oxypropylation, chemical grafting, heat treatment, hydrolysis, microwave radiation, or a combination thereof.

The amphiphilic polyoxyalkylene copolymer may comprise a copolymer of oxyethylene and oxypropylene.

In embodiments, the polyol may comprise a first amphiphilic polyoxyalkylene copolymer having a functionality of greater than or equal to 2 and less than or equal to 10, a nominal molecular weight of greater than or equal to 100 Daltons and less than or equal to 10000 Daltons, and a hydroxyl value of greater than or equal to 10 milligrams potassium hydroxide per gram and less than or equal to 400 milligrams potassium hydroxide per gram.

In embodiments, the polyol may comprise a first amphiphilic polyoxyalkylene copolymer and a second amphiphilic polyoxyalkylene copolymer. The first amphiphilic polyoxyalkylene copolymer may have a functionality of greater than or equal to 2 and less than or equal to 3, a nominal molecular weight of greater than or equal to 6000 Daltons and less than or equal to 7000 Daltons, and a hydroxyl value of greater than or equal to 20 milligrams potassium hydroxide per gram and less than or equal to 30 milligrams potassium hydroxide per gram. The second amphiphilic polyoxyalkylene copolymer may have a functionality of greater than or equal to 4 and less than or equal to 6, a nominal molecular weight of greater than or equal to 180 Daltons and less than or equal to 1000 Daltons, and a hydroxyl value of greater than or equal to 200 milligrams potassium hydroxide per gram and less than or equal to 400 milligrams potassium hydroxide per gram.

In embodiments, the polyol may comprise a polyoxyalkylene copolymer having the formula R—[(OA¹)ₐ(OA²)_{b}(OA³)_{c}-OH]ₓ, wherein R is a cyclic or acyclic aliphatic hydrocarbon group; AO¹ and AO³ are oxyethylene; AO² is oxypropylene; a, b, and c are integers; a+b+c is greater than or equal to 3 and less than or equal to 300; and x is an integer greater than or equal to 2 and less than or equal to 6.

In such case, in some embodiments, the polyoxyalkylene copolymer may be a block copolymer and a, b, and c each may be integers greater than or equal to 2.

The polyisocyanate may comprise toluylene diisocyanate (TDI), diphenylmethane diisocyanate (MDI), polyphenylenepolymethylene polyisocyanate, hexamethylene diisocyanate (HDI), isophorone diisocyanate (IPDI), or a combination thereof.

The catalyst may comprise a metal-containing catalyst and a tertiary amine catalyst.

The polyurethane material may further comprise a surfactant comprising a silicone-containing material.

The polyurethane material may further comprise a crosslinker comprising a polyol having a molecular weight of greater than or equal to 50 grams per mole and less than or equal to 300 grams per mole.

The polyurethane material may further comprise an additive comprising a flame retardant, a viscosity modifier, an antimicrobial agent, a pigment, a fragrance, an antioxidant, an UV light stabilizer, or a combination thereof.

The polyurethane material may further comprise a blowing agent.

The polyurethane material may be a polyurethane foam having a density of greater than or equal to 40 kilograms per cubic meter and less than or equal to 400 kilograms per cubic meter and a compression force deflection of greater than or equal to 4 kilopascals and less than or equal to 800 kilopascals.

A polyurethane foam, according to one or more embodiments of the present disclosure, comprises the reaction product of a polyol, lignin, a surfactant, a catalyst, and a polyisocyanate. The polyol comprises a copolymer of oxyethylene and oxypropylene. The copolymer has at least two terminal primary or secondary hydroxyl groups. The lignin is homogenously distributed throughout the polyurethane foam and constitutes, by weight, greater than or equal to 30% of the polyurethane foam. The polyurethane foam has a density of greater than or equal to 40 kilograms per cubic meter and less than or equal to 400 kilograms per cubic meter and a compression force deflection of greater than or equal to 4 kilopascals and less than or equal to 800 kilopascals.

The lignin may be a natural plant product, kraft lignin, soda lignin, organosolv lignin, sulfite lignin, lignocellulosic biomass, or a combination thereof. The lignin may not have been subjected to oxypropylation, chemical grafting, heat treatment, hydrolysis, microwave radiation, or a combination thereof. The lignin may be a particulate material having a mean particle diameter of greater than or equal to 5 micrometers and less than or equal to 250 micrometers.

The copolymer has a functionality of greater than or equal to 2 and less than or equal to 6, a nominal molecular weight of greater than or equal to 100 Daltons and less than or equal to 10000 Daltons, and a hydroxyl value of greater than or equal to 10 milligrams potassium hydroxide per gram and less than or equal to 400 milligrams potassium hydroxide per gram.

A method of manufacturing a polyurethane material, in accordance with one or more embodiments of the present disclosure comprises mixing a polyol and lignin together at a speed of greater than or equal to 200 revolutions per minute and less than or equal to 10000 revolutions per minute for a duration of less than or equal to 1 hour to form a polyol mixture. A mass ratio of the lignin to the polyol (lignin:polyol) in the polyol mixture is greater than 3:7 and less than or equal to 9:1. A catalyst is introduced into the polyol mixture to form an intermediate mixture. A polyisocyanate is introduced into the intermediate mixture to form the polyurethane material.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic depiction of an automotive vehicle comprising a polyurethane material.

In the drawings, reference numbers may be reused to identify similar and/or identical elements.

### DETAILED DESCRIPTION

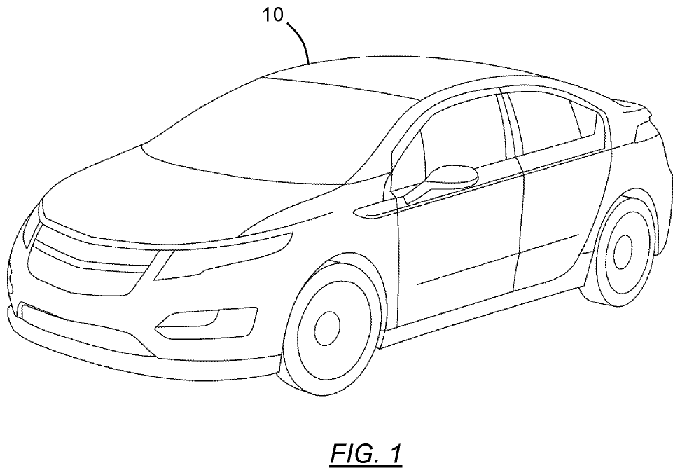

The present disclosure is directed to polyurethane materials comprising unmodified lignin and to methods of manufacturing such polyurethane materials. A polyurethane material manufactured in accordance with one or more embodiments of the present disclosure may be a polyurethane foam (e.g., an integral skin foam), a polyurethane adhesive, a polyurethane elastomer, polyurethane coating, or polyurethane fibers. In embodiments where the polyurethane material comprises a polyurethane foam, the polyurethane foam may be a flexible foam, a semi-rigid foam, or a rigid foam. Referring now to FIG. 1, in embodiments, the polyurethane material may be a component of an automotive vehicle 10. Examples of automotive vehicle components that may be formed from and/or include the presently disclosed polyurethane materials include package trays, crash pads (e.g., fascia, knee bolsters and/or door panels), vehicle seats, headrests, arm rests, consoles, headliners, steering wheels, instrument panels, baffles, load floors, and cargo and storage compartments.

In embodiments where the polyurethane material is a polyurethane foam, the polyurethane foam may have a density of greater than or equal to 40 kilograms per cubic meter (kg/m³), optionally greater than or equal to 50 kg/m³, optionally greater than or equal to 100 kg/m³, optionally greater than or equal to 150 kg/m³, optionally greater than or equal to 170 kg/m³, optionally greater than or equal to 180 kg/m³, optionally greater than or equal to 200 kg/m³, or optionally greater than or equal to 215 kg/m³, and less than or equal to 400 kg/m³, optionally less than or equal to 300 kg/m³, or optionally less than or equal to 250 kg/m³. In addition, in embodiments where the polyurethane material is a polyurethane foam, the polyurethane foam may have a compression force deflection, as measured by ASTM D1621 using a deformation value of 25% at ambient temperature (e.g., a temperature of about 25 degrees Celsius, ° C.) of greater than or equal to 45 kilopascals (kPa), optionally greater than or equal to 100 kPa, optionally greater than or equal to 120 kPa, optionally greater than or equal to 130 kPa, optionally greater than or equal to 200 kPa, optionally greater than or equal to 250 kPa, optionally greater than or equal to 300 kPa, optionally greater than or equal to 400 kPa, optionally greater than or equal to 500 kPa, or optionally greater than or equal to 600 kPa, and less than or equal to 1500 kPa, optionally less than or equal to 1000 kPa, or optionally less than or equal to 800 kPa.

A polyurethane material, in accordance with one or more embodiments of the present disclosure, comprises the reaction product of a polyol, lignin, a polyisocyanate, a catalyst, optionally a surfactant, optionally a crosslinker, optionally a blowing agent, and optionally an additive. The polyurethane material may be manufactured by forming a reaction mixture comprising the polyol, the lignin, the polyisocyanate, the catalyst, the optional surfactant, the optional crosslinker, the optional blowing agent, and the optional additive. The polyol and the lignin components may together make up the isocyanate-reactive component or resin component of the reaction mixture. The amount of each individual component in the reaction mixture may be expressed relative to the amount of the resin component in the reaction mixture. For example, the amount of each component in the reaction mixture may be expressed in parts per hundred units of resin (PHR) by weight.

The polyol is formulated to ensure the uniform and homogenous dispersion of the lignin in the reaction mixture used to form the polyurethane material and thus effectively eliminates the need for aggressive mechanical mixing (e.g., ball milling) of the reaction mixture and/or the need to chemically, thermally, or otherwise modify the lignin prior to manufacture of the polyurethane material. The polyol used to manufacture the presently disclosed polyurethane materials effectively allows for the production of polyurethane materials that have relatively high loadings of lignin (e.g., greater than 30% by weight), as well as a substantially uniform physical appearance and a substantially homogenous chemical composition. Because the polyol allows the lignin to be readily homogenously dispersed throughout the polyurethane material during the manufacturing process without aggressive mechanical mixing and without requiring prior chemical and/or thermal treatments to the lignin, the polyol can be used to effectively and consistently manufacture polyurethane materials with high lignin loadings and high reproducibility using less time and less energy than other manufacturing processes.

The polyol comprises at least one an amphiphilic polyoxyalkylene copolymer having at least two terminal primary or secondary hydroxyl groups and including hydrophilic oxyalkylene groups (e.g., oxyethylene groups) covalently bonded to hydrophobic oxyalkylene groups (e.g., oxypropyleene groups). In embodiments, the polyol may comprise at least one amphiphilic polyoxyalkylene copolymer having at least two terminal primary hydroxyl groups. The hydrophilic oxyalkylene groups and the hydrophobic oxyalkylene groups may be randomly distributed along the polymer chain of the polyol, or the hydrophilic oxyalkylene groups and the hydrophobic oxyalkylene groups may be arranged in defined blocks. Primary hydroxyl groups (—OH) are directly bonded to primary carbon atoms that are directly bonded to a single carbon atom, while secondary hydroxyl groups are directly bonded to secondary carbon atoms that are directly bonded to two carbon atoms.

The polyol may comprise at least one polyoxyalkylene copolymer having the formula (1):

R—[(OA¹)ₐ(OA²)_{b}(OA³)_{c}-OH]ₓ, (1)

where R is a polyvalent aliphatic hydrocarbon, AO¹, AO², and AO³ are each individually oxyalkylene groups, a and b are integers, c is zero or an integer, a+b+c is greater than or equal to 3 and less than or equal to 300, and x is an integer greater than or equal to 2. In embodiments, x may be greater than or equal to 3, optionally greater than or equal to 4, optionally greater than or equal to 6, or optionally greater than or equal to 8, and less than or equal to 10.

R may be a cyclic or acyclic aliphatic hydrocarbon group having 2 to 10 carbon atoms and 2 or more bonding sites. For example, the number of bonding sites on the R group in the polyoxyalkylene copolymer of formula (1) may be greater than or equal to 2, optionally greater than or equal to 3, optionally greater than or equal to 4, optionally greater than or equal to 6, or optionally greater than or equal to 8, and less than or equal to 10. Examples of aliphatic hydrocarbon groups having 2 bonding sites include ethylene, propylene, butylene, pentylene, hexylene, heptylene, octylene, nonylene, decylene, cyclopentylene, and cyclohexylene. In addition, examples of aliphatic hydrocarbon groups having 3 to 6 bonding sites include residues each obtained by removing a hydroxyl group from a polyhydric alcohol, such as trimethylolpropane, glycerin, pentaerythritol, sorbitol, 1,2,3-trihydroxycyclohexane, or 1,3,5-trihydroxycyclohexane.

The value of x in the polyoxyalkylene copolymer of formula (1) directly corresponds to the number of bonding sites on the R group. For example, when R has 2 bonding sites, the value of x is 2. In addition, the value of x corresponds to the number of isocyanate-reactive functional groups (i.e., hydroxyl groups) in the polyoxyalkylene copolymer of formula (1), which may be referred to as the “functionality” of the polyol and/or the polyoxyalkylene copolymer of formula (1). In embodiments, the polyol may have a functionality of greater than or equal to 2, optionally greater than or equal to 3, optionally greater than or equal to 4, optionally greater than or equal to 6, or optionally greater than or equal to 8, and less than or equal to 10.

In the polyoxyalkylene copolymer of formula (1), the oxyalkylene groups (AO¹, AO², and AO³) each individually have the formula —O—R¹—, where R¹ is a linear or branched divalent hydrocarbyl group, and where AO² is different than AO¹ and AO³. Examples of linear or branched chain divalent hydrocarbyl groups include ethylene, propylene, butylene, pentylene, isopropylene, hexylene, heptylene, octylene, nonylene, decylene, cyclopentylene, and cyclohexylene. Each of the oxyalkylene groups (AO¹, AO², and AO³) may be hydrophilic or hydrophobic. In embodiments, at least one of the oxyalkylene groups is a hydrophilic group (e.g., oxyethylene) and at least one of the oxyalkylene groups is a hydrophobic group (e.g., oxypropylene). In embodiments, AO¹ is a hydrophilic oxyalkylene group, AO² is a hydrophobic oxyalkylene group, and, when present, AO³ is a hydrophilic oxyalkylene group. When c is an integer greater than or equal to 1 and AO³ is a hydrophilic oxyalkylene group, the polyoxyalkylene copolymer of formula (1) may be referred to as having a hydrophilic end cap. In embodiments, the polyol may be a block copolymer. In such case, in the polyoxyalkylene copolymer of formula (1), a is an integer greater than or equal to 2, b is an integer greater than or equal to 2, and c (when present) is an integer greater than or equal to 2.

The amphiphilic polyoxyalkylene copolymer may have a nominal molecular weight of greater than or equal to 100 Daltons, optionally greater than or equal to 500 Daltons, optionally greater than or equal to 2000 Daltons, optionally greater than or equal to 3000 Daltons, optionally greater than or equal to 4000 Daltons, optionally greater than or equal to 5000 Daltons, or optionally greater than or equal to 6000 Daltons, and less than or equal to 10,000 Daltons. A hydroxyl value of the polyol is defined as the number of milligrams (mg) of potassium hydroxide (KOH) required to neutralize the acetic acid taken up on acetylation of one gram (g) of the polyol. The polyol may have a hydroxyl value of greater than or equal to 10 mg KOH/g, optionally greater than or equal to 20 mg KOH/g, and less than or equal to 400 mg KOH/g, optionally less than or equal to 350 mg KOH/g, or optionally less than or equal to 30 mg KOH/g. The polyol may have a viscosity at 77 degrees Fahrenheit (° F.) of greater than or equal to 1000 centipoise (cP), optionally greater than or equal to 1200 cP, optionally greater than or equal to 1300 cP, and less than or equal to 2500 cP, or optionally less than or equal to 1500 cP.

The polyol may be present in the reaction mixture used to form the polyurethane material in a proportion by mass of greater than or equal to 10 parts PHR, optionally greater than or equal to 20 PHR, optionally greater than or equal to 30 PHR, optionally greater than or equal to 40 PHR, or optionally greater than or equal to 50 PHR, and less than or equal to 70 PHR.

In embodiments, the polyol may comprise a first polyol and a second polyol. The first polyol and/or the second polyol may comprise at least one amphiphilic polyoxyalkylene copolymer comprising hydrophilic oxyalkylene groups covalently bonded to hydrophobic oxyalkylene groups. In embodiments, the first polyol and/or the second polyol may comprise a copolymer of oxyethylene and oxypropylene. The functionality of the first polyol may be less than that of the second polyol. For example, the first polyol may have a functionality of 3 and the second polyol may have a functionality of 4. In addition, the hydroxyl value of the first polyol may be less than that of the second polyol. For example, the first polyol may have a hydroxyl value of greater than or equal to 20 mg KOH/g and less than or equal to 30 mg KOH/g and the second polyol may have a hydroxyl value of greater than or equal to 200 mg KOH/g and less than or equal to 400 mg KOH/g. The nominal molecular weight of the first polyol may be greater than that of the second polyol. For example, the first polyol may have a nominal molecular weight of greater than or equal to 6000 Daltons and less than or equal to 7000 Daltons (e.g., about 6500 Daltons) and the second polyol may have a nominal molecular weight of greater than or equal to 150 Daltons and less than or equal to 1000 Daltons (e.g., about 740 Daltons). The viscosity of the first polyol may be less than that of the second polyol. For example, the first polyol may have a viscosity at 77° F. of greater than or equal to 1 centipoise (cP), or optionally greater than or equal to 1200 cP and less than or equal to 1500 cP (e.g., about 1370 cP) and the second polyol may have a viscosity at 77° F. of greater than or equal to 1600 cP and less than or equal to 2000 cP (e.g., about 1800 cP). In embodiments where the polyol comprises a first polyol and a second polyol, the first polyol and the second polyol each individually may be present in the reaction mixture used to form the polyurethane material in a proportion by mass of greater than or equal to 1 PHR, optionally greater than or equal to 5 PHR, optionally greater than or equal to 10 PHR, optionally greater than or equal to 20 PHR, optionally greater than or equal to 30 PHR, optionally greater than or equal to 40 PHR, or optionally greater than or equal to 50 PHR, and less than or equal to 69 PHR, or optionally less than or equal to 60 PHR.

The lignin is formulated to provide the polyurethane material with suitable rigidity while minimizing the amount of the polyol required in the reaction mixture to achieve such rigidity. The lignin may be a natural product (e.g., natural hardwood, softwood, bamboo, and/or other natural plant product) and/or a by-product of one or more manufacturing processes, including biorefining processes and various chemical pulping processes such as kraft, soda, organosolv, and/or sulfite, which may be used in papermaking. The lignin may be unmodified, meaning that the lignin may not be chemically modified, functionalized, and/or heat-treated after being produced as a natural product or as a by-product of a manufacturing process, e.g., of a biorefining process or a chemical pulping process. For example, the lignin may not have been subjected to oxypropylation, chemical grafting (e.g., grafting with polyethylene glycol), heat treatment, hydrolysis, and/or microwave liquefaction. In embodiments, the lignin may comprise unmodified kraft lignin, soda lignin, organosolv lignin, sulfite lignin (also referred to as sulfonate lignin or lignosulfonates), and/or lignocellulosic biomasss.

The lignin may comprise sulfur or may be substantially free of sulfur. The lignin may be a particulate material having a mean particle diameter of greater than or equal to 5 micrometers (μm), optionally greater than or equal to 10 μm, optionally greater than or equal to 15 μm, and less than or equal to 500 μm, optionally less than or equal to 250 μm, optionally less than or equal to 150 μm, optionally less than or equal to 110 μm, optionally less than or equal to 100 μm, optionally less than or equal to 95 μm, optionally less than or equal to 90 μm, or optionally less than or equal to 25 μm. In embodiments, the lignin may have a mean particle diameter of greater than or equal to 5 μm and less than or equal to 25 μm, or optionally greater than or equal to 5 μm and less than or equal to 15 μm. The lignin may be subjected to a milling process (e.g., a jet milling process) to achieve a desired mean particle diameter.

The lignin may be present in the reaction mixture used to form the polyurethane material in a proportion by mass of greater than or equal to 30 PHR, optionally greater than or equal to 40 PHR, optionally greater than or equal to 50 PHR, optionally greater than or equal to 60 PHR, optionally greater than or equal to 70 PHR, or optionally greater than or equal to 80 PHR, and less than or equal to 90 PHR. The lignin may constitute, by weight, greater than or equal to 30%, optionally greater than or equal to 40%, optionally greater than or equal to 50%, optionally greater than or equal to 60%, optionally greater than or equal to 70%, optionally greater than or equal to 80%, and less than or equal to 90% of the polyurethane material.

The polyisocyanate is a polyfunctional isocyanate that comprises at least two isocyanate groups (—N═C═O groups or NCO groups). For example, the polyisocyanate may comprise a diisocyanate, a triisocyanate, a tetraisocyanate, et cetera. The isocyanate groups in the polyisocyanate are formulated to react with the hydroxyl groups on the polyol and/or the lignin to form urethane linkages (—NH—(C═O)—O—) therebetween, and thereby form the polyurethane material. Examples of polyisocyanates include toluylene diisocyanate (TDI), diphenylmethane diisocyanate (MDI), mixtures of diphenylmethane diisocyanate and polyphenylenepolymethylene polyisocyanates (crude MDI), hexamethylene diisocyanate (HDI), isophorone diisocyanate (IPDI), and combinations thereof.

The polyol, the lignin, and the optional crosslinker each comprise isocyanate-reactive groups, i.e., hydroxyl groups (or —OH groups). The isocyanate index of the reaction mixture used to form the polyurethane material, as is known in the art, is the ratio of the total number of isocyanate groups in the polyisocyanate to the total number of isocyanate-reactive groups in the reaction mixture (i.e., in the polyol, the lignin, and the optional crosslinker) multiplied by 100. The polyisocyanate may be included in the reaction mixture used to form the polyurethane material in an amount such that the isocyanate index of the reaction mixture is greater than or equal to 50, optionally greater than or equal to 75, or optionally greater than or equal to 100, and less than or equal to 150, optionally less than or equal to 125, or optionally less than or equal to 110. The amount of the polyisocyanate included in the reaction mixture used to form the polyurethane material may be selected to provide the polyurethane material with a desired density and/or stiffness.

The catalyst is formulated to accelerate the reactions between and the formation of covalent linkages between the polyol, the lignin, and the polyisocyanate and thereby accelerate formation of the polyurethane material. In embodiments where the reaction mixture used to form the polyurethane material comprises the optional blowing agent and the polyurethane material is a polyurethan foam, the catalyst may be formulated to accelerate the reaction between the polyisocyanate and the blowing agent (e.g., water) to produce gas bubbles (e.g., CO₂ bubbles) in the polyurethane material. The catalyst comprises a metal catalyst and an amine catalyst. The metal catalyst may comprise an organic metal-containing catalyst and may comprise mercury, lead, tin, bismuth, potassium, zinc, or a combination thereof. Examples of metal catalysts include dibutyltin dilaurate, stannous octoate, potassium octoate, and combinations thereof. In embodiments, the metal catalyst comprises dibutyltin dilaurate. The metal catalyst may be present in the reaction mixture used to form the polyurethane material in a proportion by mass of greater than or equal to 0.5 PHR, optionally greater than or equal to 1 PHR, or optionally greater than or equal to 1.5 PHR, and less than or equal to 4 PHR, optionally less than or equal to 3 PHR, or optionally less than or equal to 2 PHR. The amine catalyst may comprise a tertiary amine. Examples of tertiary amine catalysts include diethylenetriamine (DETA), dimethylcyclohexylamine (DMCHA), dimethylethanolamine (DMEA), triethanolamine (TEA), and combinations thereof. The amine catalyst may be present in the reaction mixture used to form the polyurethane material in a proportion by mass of greater than or equal to 0.1 PHR, optionally greater than or equal to 0.3 PHR, or optionally greater than or equal to 0.5 PHR, and less than or equal to 2 PHR, or optionally less than or equal to 1 PHR.

The optional surfactant may be included to help stabilize the physical structure of the polyurethane material. Examples of surfactants include silicone-containing materials, e.g., polyether siloxanes. When present, the surfactant may be present in the reaction mixture used to form the polyurethane material in a proportion by mass of greater than or equal to 0.5 PHR, optionally greater than or equal to 1 PHR, or optionally greater than or equal to 1.5 PHR, and less than or equal to 6 PHR, optionally less than or equal to 5 PHR, or optionally less than or equal to 4 PHR.

The optional crosslinker may be included to help stabilize the polyurethane material and help form crosslinks within the polyurethane material, thereby increasing the rigidity of the material. Examples of crosslinkers include diols and polyols having molecular weights of greater than or equal to 50 grams per mole (g/mol) and less than or equal to 300 g/mol. Examples of crosslinkers include low molecular weight diols, polyols, and/or polyamines, including glycerin, glycerol, glycerol propoxylate, diethanolamine (DEA), triethanolamine (TEA), trimethylol propane, ethylene glycol, propylene glycol, dimethylthiotoluenediamine (DMTDA), 1,4-butanediol, diethyltoluene-diamine (DETDA), and combinations thereof. When present, the optional crosslinker may be present in the reaction mixture used to form the polyurethane material in a proportion by mass of greater than or equal to 1 PHR, optionally greater than or equal to 3 PHR, or optionally greater than or equal to 5 PHR, and less than 10 PHR, or optionally less than or equal to 7 PHR.

In embodiments, the reaction mixture used to form the polyurethane material may comprise less than 10 PHR, or optionally less than 7 PHR, or optionally less than 5 PHR of diols, polyols, and/or polyamines having molecular weights of less than or equal to 300 g/mol.

The optional blowing agent may be included in embodiments where the polyurethane material comprises a polyurethane foam. In such case, the optional blowing agent may be included to form or assist in the formation of gas bubbles within the polyurethane material. The blowing agent may be a chemical blowing agent that reacts with one or more components in the reaction mixture (e.g., the polyisocyanate) to form gas bubbles, or a physical blowing agent that itself forms gas bubbles in the polyurethane material. Examples of chemical blowing agents include water. Examples of physical blowing agents include gases (e.g., liquified carbon dioxide), volatile liquids having boiling points of less than or equal to 75 degrees Celsius (° C.), optionally less than or equal to 60° C., or optionally less than or equal to 50° C., and combinations thereof. Examples of volatile liquids that may be used as physical blowing agents include hydrocarbons having 4 or 5 carbon atoms (e.g., cyclo-, iso- and/or n-pentane, hydrofluorocarbons, hydrochlorofluorocarbons), oxygen-containing compounds (e.g., methyl formate and/or dimethoxymethane), hydrochlorocarbons (e.g., dichloromethane and/or 1,2-dichloroethane), ketones (e.g., acetone), aldehydes (e.g., methylal), and combinations thereof. When present, the optional blowing agent may be present in the reaction mixture used to form the polyurethane material in a proportion by mass of greater than or equal to 0.1 PHR, optionally greater than or equal to 0.5 PHR, or optionally greater than or equal to 1 PHR, and less than 5 PHR, or optionally less than or equal to 2 PHR.

The optional additive may be included to provide the polyurethane material with certain desirable properties. In embodiments, the optional additive may comprise a flame retardant, a viscosity modifier, an antimicrobial agent, a pigment, a fragrance, a stabilizer against oxidative degradation (an antioxidant), an UV light stabilizer, or a combination thereof. Examples of flame retardants include lignosulfonate-based compounds, phosphorus-containing compounds, bromine-containing compounds, polyamide-based compounds, polyetherimide-based compounds, aluminum-containing compounds, magnesium-containing compounds, and combinations thereof. Examples of viscosity modifiers include dibasic esters. When present, the optional additive may be present in the reaction mixture used to form the polyurethane material in a proportion by mass of greater than or equal to 1 PHR, optionally greater than or equal to 2 PHR, optionally greater than or equal to 5 PHR, or optionally greater than or equal to 10 PHR, and less than 25 PHR, or optionally less than or equal to 15 PHR.

### Methods

The polyurethane material may be manufactured by preparing a reaction mixture comprising the polyol, the lignin, the polyisocyanate, the catalyst, the optional surfactant, the optional crosslinker, the optional blowing agent, and the optional additive. The reaction mixture may be prepared by: (i) forming a polyol mixture comprising the polyol and the lignin, (ii) introducing the catalyst and the optional blowing agent into the polyol mixture to form an intermediate mixture, and then (iii) introducing the polyisocyanate into the intermediate mixture to form the polyurethane material. In embodiments, the polyol mixture may further comprise the optional surfactant, the optional crosslinker, and/or the optional additive, and such components may be introduced into the polyol mixture at the same time as the polyol and the lignin or subsequent thereto, prior to formation of the intermediate mixture. A mass ratio of the lignin to the polyol (lignin:polyol) in the polyol mixture may be greater than 3:7 and less than or equal to 9:1.

The polyol mixture is formed by mechanically mixing the polyol and the lignin together, for example, using a centrifugal mixer, a disperser (e.g., using a disk-type blade), or a paddle mixer for a duration of about 5 minutes to about 1 hour at a speed of about 1000 revolutions per minute (rpm) to about 3000 rpm, or about 2000 rpm. After the polyol and the lignin are mixed together, the polyol mixture may be allowed to “soak” for a duration of greater than or equal to 1 hour, optionally greater than or equal to 24 hours, or optionally greater than or equal to 1 week, and less than or equal to 2 years. The optional surfactant, the optional crosslinker, and/or the optional additive may be added to the polyol mixture before or after soaking. The polyol mixture may be mixed at a temperature of greater than or equal to 50° C. and less than or equal to 75° C. Heat may be generated in the polyol mixture during the mixing process, for example, by heat generated due to frictional forces during the mixing process itself or by external application of heat thereto, for example, by heating the polyol mixture in an oven.

The intermediate mixture is formed by mechanically mixing the catalyst and the optional blowing agent into the polyol mixture, for example, using a centrifugal mixer, a disperser (e.g., using a disk-type blade), or a paddle mixer for a duration of about 30 seconds to about 1 hour at a speed of about 1000 revolutions per minute (rpm) to about 3000 rpm, or about 2000 rpm.

The final reaction mixture is formed by mechanically mixing the polyisocyanate into the intermediate mixture, for example, using a centrifugal mixer, a disperser (e.g., using a disk-type blade), or a paddle mixer for a duration of about 1 second to about 1 minutes at a speed of about 1000 revolutions per minute (rpm) to about 3000 rpm, or about 2000 rpm. After the polyisocyanate is mixed into the intermediate mixture, the reaction mixture may be transferred to a mold or other container and allowed to cure and solidify to form the polyurethane material.

### Experimental

Polyurethane foams were prepared from different reaction mixtures and the density and compression force deflection (CFD) of the polyurethane foams was measured. Dibutyltin dilaurate (DBTDL) was used as the metal catalyst and was purchased from Sigma Aldrich. Pluracol® 380 and Pluracol® 1168 were used as polyols and were supplied by BASF. VORASURF DC 6070 was used as a surfactant and was supplied by DOW. TEGOAMIN® E 10 was used as the tertiary amine catalyst and was supplied by Evonik. Mondur MR Light was used as the polyisocyanate and was supplied by Covestro. The lignin was provided by SweetWater Energy Inc. and was used as received, other than being jet-milled to an average particle diameter of 10 μm. Max 100 Long FlackTek cups were purchased from Fischer Scientific. As published by BASF Corporation, Pluracol® 380 has a nominal functionality of 3, a hydroxyl value of 24.0-26.0 mg KOH/g, a nominal molecular weight of 6500 Daltons, a viscosity at 77 degrees Fahrenheit (° F.) of 1370 cP, and a maximum of 0.05 wt. % water. Pluracol® 1168 has a nominal functionality of 4, a hydroxyl value of 285-315 mg KOH/g, a nominal molecular weight of 740 Daltons, a viscosity at 77 degrees Fahrenheit (° F.) of 1800 cP, and a maximum of 0.10 wt. % water.

Density Measurements: For Comparative Example 2 and Examples 3 through 6: From the main cured foam block, a rectangular block with measurements approximately 25 mm height×50 mm width×50 mm length were cut. Actual measurements were confirmed using digital calipers on an individual foam sample basis. For Comparative Example 1: From the main cured foam block, an approximately 10 mm thick cross section was cut. Once cut, a 30 mm die cutter was used to axially punch a 30 mm diameter disc from the 10 mm thick cross section, resulting in a cylindrical foam piece with dimensions approximately 10 mm by 30 mm. Actual measurements were confirmed using digital calipers on an individual foam sample basis. Cut pieces of foam were then weighed using a laboratory balance, allowing for calculation of individual foam density.

Compression Force Deflection (25%) Measurements: Compression Force Deflection tests were performed following ASTM D1621 using a deformation value of 25%. Tests were performed on an Instron equipped with a stationary rectangular bottom platform and a movable compression attachment purchased from Instron. Blocks of foams cut from Comparative Example 1 and Examples 2 through 5 used for density calculations were used for determination of CFD_{25%}. Samples were compressed to 25% deformation and the max force measured. CFD_{25%} values were determined by dividing the max force at 25% deformation by the cross-sectional surface area of the sample.

### Comparative Example 1: Synthesis of Base Foam 1

A polyol mixture comprising Pluracol® 380 (20.0 g, 100 phr) and VORASURF DC 6070 (400 mg, 2 phr) was prepared in a Max 100 Long FlackTek cup and mixed at 2000 rpm for 5 minutes in a FlackTek mixer. Then, DBTDL (400 mg, 2 phr), Tegoamin® E 10 (100 mg, 0.5 phr), and deionized water (200 mg, 1 phr) were added to the polyol mixture and mixed at 2000 rpm for 1 minute using a disperser blade attached to an overhead mixer to form an intermediate mixture. Mondur MR Light (4.15 g, 1 eq. wrt polyol) was added to the intermediate mixture in the cup and mixed at 2000 rpm with the same overhead mixer for 15 seconds to form a polyurethane foam. The foam was allowed to rest at room temperature for 72 hours before 3 samples of the foam were subjected to density measurements. The resulting polyurethane foam had a density of 130 kg/m³.

### Comparative Example 2: Synthesis of Base Foam 2

A polyol mixture comprising Pluracol® 1168 (8.0 g, 100 phr) and VORASURF DC 6070 (120 mg, 1.5 phr) was prepared in a Max 100 Long FlackTek cup and mixed at 2000 rpm for 3 minutes in a FlackTek mixer. Then, DBTDL (160 mg, 2 phr), Tegoamin® E 10 (40 mg, 0.5 phr) and deioniozed water (120 mg, 1.5 phr) were added to the polyol mixture and mixed at 2000 rpm for 3 minutes using a disperser blade attached to an overhead mixer to form an intermediate mixture. Mondur MR Light (8.21 g, 1.1 eq. wrt polyol) was added to the intermediate mixture in the cup and mixed at 2000 rpm with the same overhead mixer for 5 seconds to form a polyurethane foam. The foam was allowed to rest at room temperature for at least 72 hours before 3 samples of the foam were subjected to density and compressive force deflection measurements. The resulting polyurethane foam had a density of 79 kg/m³ and a CFD_{25%} value of 623 kilopascals (kPa).

### Example 3: Synthesis of Base Foam with 50 Phr Lignin

A polyol mixture comprising Pluracol® 380 (10.0 g, 50 phr), lignin (10.00 g, 50 phr), and VORASURF DC 6070 (800 mg, 4 phr) was prepared in a Max 100 Long FlackTek cup and mixed at 2000 rpm for 3 minutes in a FlackTek mixer. Then, DBTDL (400 mg, 2 phr) and Tegoamin® E 10 (100 mg, 0.5 phr) were added to the polyol mixture and mixed at 2000 rpm for 8 minutes in a FlackTek mixer to form an intermediate mixture. Immediately after the intermediate mixture was formed, Mondur MR Light (5.64 g, 0.75 eq. wrt polyol) was added to the intermediate mixture in the cup and mixed at 2000 rpm with the same FlackTek mixer for 10 seconds to form a polyurethane foam. The foam was allowed to rest at room temperature for at least 72 hours before 3 samples of the foam were subjected to density and compressive force deflection measurements. The resulting polyurethane foam had a density of 215±5 kg/m³ and a CFD_{25%} value of 140±9 kPa.

### Example 4: Synthesis of Base Foam with 50 Phr Lignin

A polyol mixture comprising Pluracol® 380 (10.0 g, 50 phr), lignin (10.00 g, 50 phr) and VORASURF DC 6070 (800 mg, 4 phr) was prepared in a Max 100 Long FlackTek cup and mixed at 2000 rpm for 3 minutes in a FlackTek mixer. Then, DBTDL (400 mg, 2 phr) and Tegoamin® E 10 (100 mg, 0.5 phr) were added to the polyol mixture and mixed at 2000 rpm for 8 minutes in a FlackTek mixer to form an intermediate mixture. Immediately after the intermediate mixture was formed, Mondur MR Light (5.64 g, 1 eq. wrt polyol) was added to the intermediate mixture in the cup and mixed at 2000 rpm with the same FlackTek mixer for 10 seconds to form a polyurethane foam. The foam was allowed to rest at room temperature for at least 72 hours before 3 samples of the foam were subjected to density and compressive force deflection measurements. The resulting polyurethane foam had a density of 173±19 kg/m³ and a CFD_{25%} value of 135±1 kPa.

### Example 5: Synthesis of Base Foam with 60 Phr Lignin

A polyol mixture comprising Pluracol® 380 (8.0 g, 40 phr), lignin (12.00 g, 60 phr) and VORASURF DC 6070 (800 mg, 4 phr) was prepared in a Max 100 Long FlackTek cup and mixed at 2000 rpm for 3 minutes in a FlackTek mixer. Then, DBTDL (400 mg, 2 phr) and Tegoamin® E 10 (100 mg, 0.5 phr) were added to the polyol mixture and mixed at 2000 rpm for 8 minutes in a FlackTek mixer to form an intermediate mixture. Immediately after the intermediate mixture was formed, Mondur MR Light (5.64 g, 0.75 eq. wrt polyol) was added to the intermediate mixture in the cup and mixed at 2000 rpm with the same FlackTek mixer for 10 seconds to form a polyurethane foam. The foam was allowed to rest at room temperature for at least 72 hours before 3 samples of the foam were subjected to density and compressive force deflection measurements. The resulting polyurethane foam had a density of 216±3 kg/m³ and a CFD_{25%} value of 624±54 kPa.

### Example 6: Synthesis of Base Foam with 60 Phr Lignin

A polyol mixture comprising Pluracol® 380 (8.0 g, 40 phr), lignin (12.00 g, 60 phr) and VORASURF DC 6070 (800 mg, 4 phr) was prepared in a Max 100 Long FlackTek cup and mixed at 2000 rpm for 3 minutes in a FlackTek mixer. Then, DBTDL (400 mg, 2 phr) and Tegoamin® E 10 (100 mg, 0.5 phr) were added to the polyol mixture and mixed at 2000 rpm for 8 minutes in a FlackTek mixer to form an intermediate mixture. Immediately after the intermediate mixture was formed, Mondur MR Light (5.64 g, 1 eq. wrt polyol) was added to the intermediate mixture in the cup and mixed at 2000 rpm with the same FlackTek mixer for 10 seconds to form a polyurethane foam. The foam was allowed to rest at room temperature for at least 72 hours before 3 samples of the foam were subjected to density and compressive force deflection measurements. The resulting polyurethane foam had a density of 185±15 kg/m³ and a CFD_{25%} value of 408±4 kPa.

### Example 7: Synthesis of Base Foam with Two Polyols and 50 Phr Lignin

A polyol mixture comprising Pluracol® 380 (9.0 g, 45 phr) and Pluracol® 1168 (1.0 g, 5 phr) was prepared in a Max 100 Long FlackTek cup and mixed in a FlackTek mixer at 2000 rpm for 2 minutes. Then, Sunburst hydrolysis lignin (10.00 g, 50 phr) and VORASURF DC 6070 (800 mg, 4 phr) were added to the polyol mixture and mixed again at 2000 rpm for 3 minutes. DBTDL (400 mg, 2 phr) and Tegoamin® E 10 (100 mg, 0.5 phr) were added to the polyol mixture and mixed at 2000 rpm for 8 minutes in a FlackTek mixer to form an intermediate mixture. Immediately after the intermediate mixture was formed, Mondur MR Light (8.17 g, 1.0 eq. wrt polyol) was added to the intermediate mixture in the cup and mixed at 2000 rpm with the same FlackTek mixer for 10 seconds to form a polyurethane foam. The foam was allowed to rest at room temperature for at least 72 hours before 3 samples of the foam were subjected to density and compressive force deflection measurements. The resulting polyurethane foam had a density of 187 kg/m³ and a CFD_{25%} value of 323 kPa.

### Example 8: Synthesis of Base Foam with Crosslinker and 50 Phr Lignin

A polyol mixture comprising Pluracol® 380 (10.0 g, 50 phr), Sunburst hydrolysis lignin (10.00 g, 50 phr), diethanolamine (1.0 g, 5 phr) and VORASURF DC 6070 (800 mg, 4 phr) was prepared in a Max 100 Long FlackTek cup and mixed at 2000 rpm for 3 minutes in a FlackTek mixer. Then, DBTDL (400 mg, 2 phr) and Tegoamin® E 10 (100 mg, 0.5 phr) were added to the polyol mixture and mixed at 2000 rpm for 8 minutes in a FlackTek mixer to form an intermediate mixture. Immediately after the intermediate mixture was formed, Mondur MR Light (10.10 g, 1.0 eq. wrt polyol and hydroxyl groups of diethanolamine) was added to the intermediate mixture in the cup and mixed at 2000 rpm with the same FlackTek mixer for 10 seconds to form a polyurethane foam. The foam was allowed to rest at room temperature for at least 72 hours before 3 samples of the foam were subjected to density and compressive force deflection measurements. The resulting polyurethane foam had a density of 158 kg/m³ and a CFD_{25%} value of 267 kPa.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

As used herein, the phrase at least one of A, B, and C should be construed to mean a logical (A OR B OR C), using a non-exclusive logical OR, and should not be construed to mean “at least one of A, at least one of B, and at least one of C.”

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

What is claimed is:

1. A polyurethane material comprising the reaction product of:
a polyol comprising an amphiphilic polyoxyalkylene copolymer having at least two terminal primary or secondary hydroxyl groups, the amphiphilic polyoxyalkylene copolymer comprising hydrophilic oxyalkylene groups covalently bonded to hydrophobic oxyalkylene groups;
lignin;
a catalyst; and
a polyisocyanate.

2. The polyurethane material of claim 1, wherein the lignin is a particulate material having a mean particle diameter of greater than or equal to 5 micrometers and less than or equal to 250 micrometers.

3. The polyurethane material of claim 1, wherein the lignin constitutes, by weight, greater than 30% of the polyurethane material, and wherein the lignin is homogenously distributed throughout the polyurethane material.

4. The polyurethane material of claim 1, wherein the lignin is a natural plant product, kraft lignin, soda lignin, organosolv lignin, sulfite lignin, lignocellulosic biomass, or a combination thereof, and wherein the lignin has not been subjected to oxypropylation, chemical grafting, heat treatment, hydrolysis, microwave radiation, or a combination thereof.

5. The polyurethane material of claim 1, wherein the amphiphilic polyoxyalkylene copolymer comprises a copolymer of oxyethylene and oxypropylene.

6. The polyurethane material of claim 1, wherein the polyol comprises a first amphiphilic polyoxyalkylene copolymer having a functionality of greater than or equal to 2 and less than or equal to 10, a nominal molecular weight of greater than or equal to 100 Daltons and less than or equal to 10000 Daltons, and a hydroxyl value of greater than or equal to 10 milligrams potassium hydroxide per gram and less than or equal to 400 milligrams potassium hydroxide per gram.

7. The polyurethane material of claim 6, wherein the first amphiphilic polyoxyalkylene copolymer has a functionality of greater than or equal to 2 and less than or equal to 3, a nominal molecular weight of greater than or equal to 6000 Daltons and less than or equal to 7000 Daltons, and a hydroxyl value of greater than or equal to 20 milligrams potassium hydroxide per gram and less than or equal to 30 milligrams potassium hydroxide per gram, and wherein the polyol further comprises a second amphiphilic polyoxyalkylene copolymer having a functionality of greater than or equal to 4 and less than or equal to 6, a nominal molecular weight of greater than or equal to 180 Daltons and less than or equal to 1000 Daltons, and a hydroxyl value of greater than or equal to 200 milligrams potassium hydroxide per gram and less than or equal to 400 milligrams potassium hydroxide per gram.

8. The polyurethane material of claim 1, wherein the polyol comprises a polyoxyalkylene copolymer having the formula R—[(OA¹)ₐ(OA²)_{b}(OA³)_{c}-OH]ₓ, wherein:
R is a cyclic or acyclic aliphatic hydrocarbon group;
AO¹ and AO³ are oxyethylene;
AO² is oxypropylene;
a, b, and c are integers;
a+b+c is greater than or equal to 3 and less than or equal to 300; and
x is an integer greater than or equal to 2 and less than or equal to 6.

9. The polyurethane material of claim 8, wherein the polyoxyalkylene copolymer is a block copolymer, and wherein a, b, and c are each integers greater than or equal to 2.

10. The polyurethane material of claim 1, wherein the polyisocyanate comprises toluylene diisocyanate (TDI), diphenylmethane diisocyanate (MDI), polyphenylenepolymethylene polyisocyanate, hexamethylene diisocyanate (HDI), isophorone diisocyanate (IPDI), or a combination thereof.

11. The polyurethane material of claim 1, wherein the catalyst comprises a metal-containing catalyst and a tertiary amine catalyst.

12. The polyurethane material of claim 1, further comprising a surfactant comprising a silicone-containing material.

13. The polyurethane material of claim 1, further comprising a crosslinker comprising a polyol having a molecular weight of greater than or equal to 50 grams per mole and less than or equal to 300 grams per mole.

14. The polyurethane material of claim 1, further comprising an additive comprising a flame retardant, a viscosity modifier, an antimicrobial agent, a pigment, a fragrance, an antioxidant, an UV light stabilizer, or a combination thereof.

15. The polyurethane material of claim 1, further comprising a blowing agent.

16. The polyurethane material of claim 1, wherein the polyurethane material is a polyurethane foam having a density of greater than or equal to 40 kilograms per cubic meter and less than or equal to 400 kilograms per cubic meter and a compression force deflection of greater than or equal to 4 kilopascals and less than or equal to 800 kilopascals.

17. A polyurethane foam comprising the reaction product of:
a polyol comprising a copolymer of oxyethylene and oxypropylene, the copolymer having at least two terminal primary or secondary hydroxyl groups;
lignin, the lignin being homogenously distributed throughout the polyurethane foam and constituting, by weight, greater than or equal to 30% of the polyurethane foam;
a surfactant;
a catalyst; and
a polyisocyanate,
wherein the polyurethane foam has a density of greater than or equal to 40 kilograms per cubic meter and less than or equal to 400 kilograms per cubic meter and a compression force deflection of greater than or equal to 4 kilopascals and less than or equal to 800 kilopascals.

18. The polyurethane foam of claim 17, wherein the lignin is a natural plant product, kraft lignin, soda lignin, organosolv lignin, sulfite lignin, lignocellulosic biomass, or a combination thereof, wherein the lignin has not been subjected to oxypropylation, chemical grafting, heat treatment, hydrolysis, microwave radiation, or a combination thereof, and wherein the lignin is a particulate material having a mean particle diameter of greater than or equal to 5 micrometers and less than or equal to 250 micrometers.

19. The polyurethane foam of claim 17, wherein the copolymer has a functionality of greater than or equal to 2 and less than or equal to 6, a nominal molecular weight of greater than or equal to 100 Daltons and less than or equal to 10000 Daltons, and a hydroxyl value of greater than or equal to 10 milligrams potassium hydroxide per gram and less than or equal to 400 milligrams potassium hydroxide per gram.

20. A method of manufacturing a polyurethane material, the method comprising:
mixing a polyol and lignin together at a speed of greater than or equal to 200 revolutions per minute and less than or equal to 10000 revolutions per minute for a duration of less than or equal to 1 hour to form a polyol mixture, wherein a mass ratio of the lignin to the polyol (lignin:polyol) in the polyol mixture is greater than 3:7 and less than or equal to 9:1;
introducing a catalyst into the polyol mixture to form an intermediate mixture; and
introducing a polyisocyanate into the intermediate mixture to form the polyurethane material.
